(19) United States
(12) Patent Application Publication
(10) Pub. No.: US 2026/0178082 A1
(43) Pub. Date: Jun. 25, 2026

(54) MOBILE DEVICE WITH FLEXIBLE DISPLAY AND FLEXIBLE ANTENNA

(71) Applicant: Motorola Mobility LLC, Chicago, IL (US)

(72) Inventors: Junsheng Zhao, Vernon Hills, IL (US); Xuyuan Pan, Chicago, IL (US); Md Faisal Abedin, Lisle, IL (US); Mohammed Abdul-Gaffoor, Palatine, IL (US)

(73) Assignee: Motorola Mobility LLC, Chicago, IL (US)

(21) Appl. No.: 18/987,070

(22) Filed: Dec. 19, 2024

(51) Int. Cl. G06F 1/16; H01Q 1/08; H01Q 1/42

(52) U.S. Cl. CPC G06F 1/1652; H01Q 1/085; H01Q 1/427

(57) ABSTRACT

A mobile device with flexible display and flexible antenna includes a flexible housing bendable to a plurality of flexed configurations. The flexible antenna is disposed within the flexible housing and is shaped to bend with the flexible housing and the flexible display. The flexible antenna includes a flexible section shaped to lengthen while the flexible housing and flexible display bend and contract while the flexible housing and flexible display are straightened. The flexible antenna may further include a straightened section. The flexible section and the straightened section can transmit and receive wireless signals in a first frequency range. The straightened section can additionally transmit and receive wireless signals in a second frequency range.

### BACKGROUND

As technology has advanced our uses for mobile devices have expanded. One such use is small mobile devices, such as smartphones, which have become increasingly powerful despite their small size. These mobile devices provide a great deal of portable processing power but are not without their problems. One such problem is that as the processing power increases, such devices are often configured with additional functionality that may utilize the increased processing power. However, in supporting such functionality, such devices are often fitted with additional components that tend to increase a size of the devices. Thus, it can be challenging to balance increasing device functionality without substantially increasing the size of such devices. Devices that prioritize functionality may be cumbersome and less portable, while devices that prioritize reduced size may include less functionality desired by users. This can lead to user frustration.

### BRIEF DESCRIPTION OF THE DRAWINGS

Embodiments of a mobile device with flexible display and flexible antenna are described with reference to the following drawings. The same numbers are used throughout the drawings to reference like features and components:

FIG. 1 illustrates an example system implementing the techniques discussed herein;

FIG. 2 illustrates an example implementation of the mobile device with flexible display and flexible antenna;

FIGS. 3-6 illustrate example implementations of a mobile device with flexible display and flexible antenna in a flexed configuration;

FIGS. 7 and 8 illustrate additional flexed configurations of the mobile device with flexible display and flexible antenna;

FIGS. 9-12 illustrate side views of example implementations of the flexible antenna of the mobile device;

FIG. 13 illustrates various components of an example mobile device that can implement embodiments of the techniques discussed herein.

### DETAILED DESCRIPTION

Implementations of a mobile device with a flexible display and flexible antenna are discussed herein. Generally, a mobile device (e.g., smartphone) can include a display (e.g., a screen used to display one or more graphical user interfaces) and supports functionality including wireless communications for messaging, phone calls, internet browsing, etc. For example, the mobile device may be operable to connect to one or more networks for wireless communication operations. Such mobile devices often have a relatively small form factor for increased portability and include a rigid casing that houses components such as a processor, an image sensor, a speaker, etc.

The mobile device of the present disclosure includes a flexible housing that is bendable in order to adjust a shape of the mobile device and provide increased functionality in a variety of situations. The mobile device includes a flexible housing that is capable of bending along a plurality of axes. While adjusted to a flexed configuration, the mobile device may have a C-shaped profile, U-shaped profile, S-shaped profile, or other type of profile shape. The mobile device is thus bendable to shapes that are self-supporting, e.g., for standing the mobile

device on a surface without using additional components to maintain the standing position of the mobile device. Further, the mobile device is bendable to shapes that may enable the mobile device to be worn by a user, such as a shape that wraps around a wrist, arm, or other portion of the body of the user.

The flexibility of the mobile device may thus enable the mobile device to be more readily accessible to a user. Additionally, the flexibility may increase an ease of use of the mobile device in situations that would otherwise be unsupported by inflexible devices. For example, the mobile device may bend to a self-supporting configuration in which the flexible display is angled relative to a surface on which the mobile device is located. This may support viewing of videos, images, and/or other media displayed by the mobile device from an increased number of angles and/or viewing positions (e.g., viewing positions directly above the mobile device as well as viewing positions at the sides of the mobile device).

Although the flexibility of the mobile device provides support for the additional uses of the mobile device described above, the flexibility can introduce challenges. For example, while the flexible display and the flexible housing are capable of bending, other components within the mobile device such as the processor, image sensor, etc. may not be capable of bending. Therefore, such components are arranged within the housing in positions in which the bending of the flexible housing and the flexible display does not result in bending of the inflexible components. In some cases, components may have particular size and/or length parameters associated with functionality of such components that make it difficult or impossible to arrange such components within the flexible housing without subjecting the components to bending or without compromising the functionality of the components. In such cases, some approaches may omit inclusion of the components by the mobile device. However, by omitting the components, the functionality of the mobile device may be hindered.

The techniques discussed herein address the above-described issues by implementing a mobile device including a flexible display and a flexible antenna configured to bend and deform without degradation (e.g., without strain, tearing, etc.). The flexible antenna includes a flexible section shaped to bend along with the flexible display during conditions in which the mobile device is adjusted to a flexed configuration. The flexible antenna is configured such that an electronic signal quality (e.g., signal strength) associated with the flexible antenna and a network connectivity of the mobile device is not degraded while the mobile device is in flexed configurations. For example, the electronic signal quality associated with the flexible antenna may be substantially similar during conditions in which the mobile device is in a straightened configuration relative to conditions in which the mobile device is in any of a plurality of flexed configurations.

Additionally, by configuring the flexible antenna with the flexible section, a length of the flexible antenna may extend along a larger span of the mobile device without experiencing degradation. Inflexible antennas may be limited to arrangement at portions of the mobile device that do not bend and thus may have a relatively short length. The short length of the inflexible antennas may result in lower signal quality and lower connectivity of the mobile device. In contrast to inflexible antennas, the flexibility of the flexible antenna enables the length of the flexible antenna to be increased. In particular, the flexible antenna is able to span bendable portions of the mobile device. The increased length of the antenna may support a larger range of electronic signal frequencies that can be received and/or transmitted by the flexible antenna, such as low-band frequencies (e.g., less than one gigahertz), mid-band frequencies (e.g., greater than one gigahertz and less than six gigahertz), and high-band frequencies (e.g., up to forty gigahertz or more).

Further, in some implementations, the flexible antenna spans bendable portions of the mobile device as well as unbendable portions of the mobile device. For example, the flexible antenna can be configured to extend along a sidewall of a flexible housing of the mobile device as well as an end of the flexible housing, where the sidewall is longer (e.g., twice as long) as the end and is configured to bend while the end does not bend. Sections of the flexible antenna arranged at bendable portions of the mobile device may have a different shape relative to sections of the flexible antenna that are arranged at unbendable portions of the mobile device. The shape of the flexible antenna may thus be configured to support reception and transmission of electronic signals within specific frequency ranges and/or different signal modalities while maintaining a high signal quality independent of whether the mobile device is flexed or straightened. The shape of the flexible antenna can be further configured based on the specific flexibility range of the mobile device and the thickness and length of the mobile device.

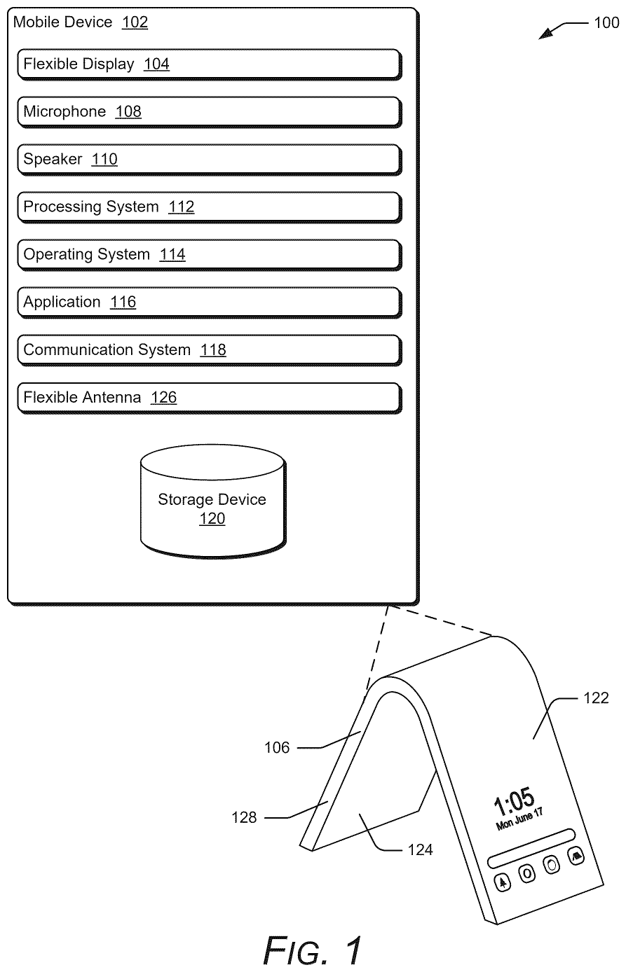

FIG. 1 illustrates an example system 100 implementing the techniques discussed herein. The system 100 includes a mobile device 102 that can be, or include, many different types of computing or mobile devices. For example, the mobile device 102 can be a smartphone or other wireless phone, a camera (e.g., compact or single-lens reflex), a wearable device (e.g., a smartwatch, an augmented reality headset or device, a virtual reality headset or device), a personal media player, a personal navigating device (e.g., global positioning system), an entertainment device (e.g., a gaming console, a portable gaming device, a streaming media player, a digital video recorder, a music or other audio playback device), a video camera, an Internet of Things (IoT) device, an automotive computer, and so forth. Although typically a smaller device, the mobile device 102 can be larger (e.g., a tablet or phablet computer, a notebook computer (e.g., netbook or ultrabook), a laptop computer, and so forth.

The mobile device 102 includes a flexible display 104 that can be configured as any suitable type of display, such as an organic light-emitting diode (OLED) display, active matrix OLED display, liquid crystal display (LCD), in-plane shifting LCD, and so forth. The flexible display 104 can be touch enabled or not touch enabled. A touch-enabled device refers to a device that receives touch inputs via the display (e.g., a touchscreen). A touch-enabled device may also receive inputs via other input mechanisms, such as trackpad, mouse, physical keyboard, and so forth. A non-touch-enabled device refers to a device that does not receive touch inputs via the display (e.g., a touchscreen). Accordingly, a non-touch-enabled receives inputs via other input mechanisms, such as trackpad, mouse, physical keyboard, and so forth.

In the implementations described herein, the flexible display 104 is bendable to accommodate various flexed configurations of the mobile device 102. The flexible display 104 may be disposed within a flexible housing 106 of the mobile device 102 (e.g., housed within an interior of the flexible housing 106 of the mobile device 102), with the flexible housing 106 also bendable in a manner similar to the flexible display 104. For example, the flexible display 104 and the flexible housing 106 may bend together such that the mobile device 102 is self-supporting on a surface on which the mobile device 102 is located. Various examples of flexed configurations of the mobile device 102 are described further below with reference to the other figures.

The mobile device 102 also includes a microphone 108 and a speaker 110. The microphone 108 can be configured as any suitable type of microphone incorporating a transducer that converts sound into an electrical signal, such as a dynamic microphone, a condenser microphone, a piezoelectric microphone, and so forth. The speaker 110 can be configured as any suitable type of speaker incorporating a transducer that converts an electrical

signal into sound, such as a dynamic loudspeaker using a diaphragm, a piezoelectric speaker, non-diaphragm based speakers, and so forth.

The mobile device 102 also includes a processing system 112 that includes one or more processors, each of which can include one or more cores. The processing system 112 is coupled with, and may implement functionalities of, any other components or modules of the mobile device 102 that are described herein. In one or more embodiments, the processing system 112 includes a single processor having a single core. Alternatively, the processing system 112 includes a single processor having multiple cores or multiple processors (each having one or more cores).

The mobile device 102 also includes an operating system 114. The operating system 114 manages hardware, software, and firmware resources in the mobile device 102. The operating system 114 manages one or more applications 116 running on the mobile device 102 and operates as an interface between applications 116 and hardware components of the mobile device 102.

The mobile device 102 also includes a communication system 118. The communication system 118 is operable to manage access to networks and communication with various other devices. For example, the communication system 118 is operable to communicate electronically (e.g., via a wired or wireless connection) with other devices over a network such as a wireless cellular network. The mobile device 102 can be connected to one or more external devices and communicate with the external devices using any of a variety of wired or wireless connections, such as USB, USB-C, WiFi™, WiFi™ IP (Internet Protocol), USB IP, DisplayPort, High-Definition Multimedia Interface (HDMI), and so forth.

The mobile device 102 also includes a storage device 120. The storage device 120 can be implemented using any of a variety of storage technologies, such as magnetic disk, optical disc, Flash, or other solid state memory, and so forth. The storage device 120 can store various program instructions and data for the operating system 114 and/or application 116.

In some implementations, the flexible display 104 and the flexible housing 106 may be integrated together as a single unit (e.g., such that the flexible display 104 is glued or otherwise fixed to the flexible housing 106, the flexible display 104 is molded together with the flexible housing 106, etc.).

The flexible display 104 is depicted arranged at a first side 122 of the flexible housing 106. However, in some implementations the flexible display 104 may be arranged at a second side 124 of the flexible housing 106. Further, in some implementations, the flexible display 104 may be integrated with the flexible housing 106 at the first side 122 of the flexible housing 106, and a second flexible display may be integrated with the flexible housing 106 at the second side 124 of the flexible housing 106.

The mobile device 102 also includes a flexible antenna 126. The flexible antenna 126 is employed by the mobile device 102 for receiving and/or transmitting wireless signals. For example, the flexible antenna 126 may be employed along with communication system 118 for communicating wirelessly with one or more other devices, for network access, etc. The configurations of the flexible antenna 126 as described herein increase connectivity capabilities (e.g., signal strength, gain, etc.) of the mobile device 102 while the mobile device 102 is in a straightened configuration and additionally while the mobile device 102 is in any of a plurality of flexed configurations.

As described below, the flexible antenna 126 is configured to extend along a length of a first sidewall 128 of the mobile device 102. The first sidewall 128 may be formed by the flexible housing 106. The flexible antenna 126 includes a flexible section that is shaped to increase a flexibility of the flexible antenna 126 such that the flexible antenna 126 is able to bend with the flexible housing 106 and the flexible display 104 without degradation of the flexible antenna 126 and without degradation of wireless electronic signal reception and/or transmission by the flexible antenna 126 (e.g., without degradation of gain of the flexible antenna 126). To do so, the flexible section of the flexible antenna 126 may lengthen while the flexible housing 106 bends (e.g., flexes) and may contract while the flexible housing 106 is straightened. Thus, the flexible antenna 126 supports a variety of connectivity of the mobile device 102 that would otherwise not be possible without significantly increasing a size of the mobile device 102 and/or including additional components such as external antennas.

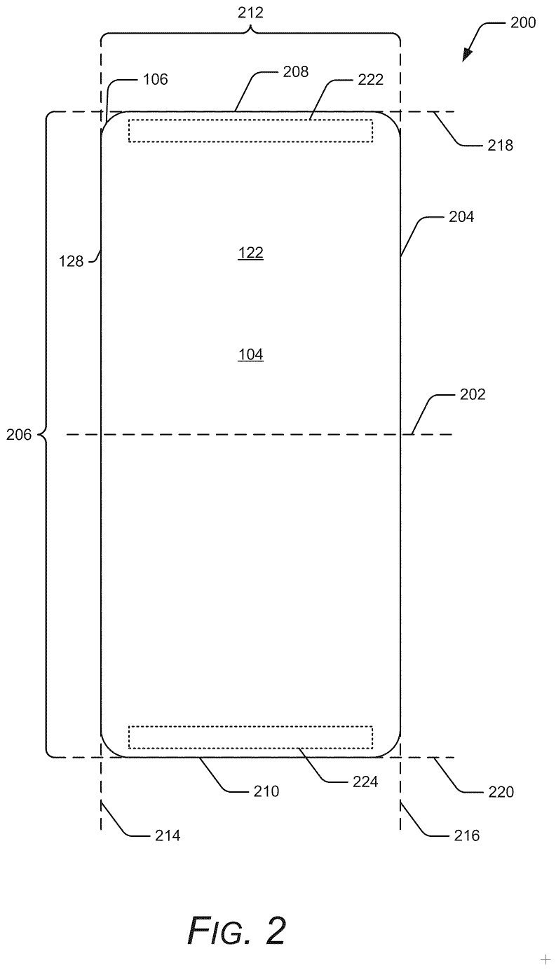

In some instances, the flexible housing 106, flexible display 104, and flexible antenna 126 may bend together by more than thirty degrees, forty-five degrees, sixty degrees, ninety degrees, etc. relative to a configuration in which the flexible housing 106, the flexible display 104, and the flexible antenna 126 are straightened. In the straightened configuration, the flexible housing 106 and the flexible display 104 are relatively flat and planar as depicted by FIG. 2 and described below.

The signal efficiency of the flexible antenna 126 is substantially similar whether the mobile device 102 is in the straightened configuration or one of the flexed configurations. Similarly, the return loss of the flexible antenna 126 is substantially similar whether the mobile device 102 is in the straightened configuration or one of the flexed configurations. Thus, the flexible antenna 126 is able to maintain a high quality of wireless electronic signal communications (e.g., maintain a gain of the flexible antenna 126) in a variety of conditions.

FIG. 2 illustrates an example 200 of the mobile device 102. The depicted view shows the first side 122 of the flexible housing 106 along with the flexible display 104. The figure depicts various axes, and some of the axes may be shown in other views for comparison of the different perspectives shown. An axis 202 is shown arranged at a center of the flexible display 104 and extends between the first sidewall 128 and a second sidewall 204 of the flexible housing 106. The first sidewall 128 and the second sidewall 204 form a thickness of the flexible housing 106 (e.g., a thickness from the first side 122 to the second side 124). In the depicted example, the first sidewall 128 and the second sidewall 204 each have a length 206 in a direction perpendicular to the axis 202. A first end 208 and a second end 210 each have a length 212 in a direction parallel to the axis 202 and extend perpendicular to the first sidewall 128 and the second sidewall 204.

In this example, the length 206 is larger than the length 212. The length 206 may be, for example, twice an amount of length compared to the length 212, such that an aspect ratio of the flexible display 104 is 2:1. However, other relative lengths are possible leading to other aspect ratios such as 1.5:1, 2.5:1, etc.

In the example 200, the mobile device 102 is in the straightened configuration. In this configuration, the flexible display 104 and the flexible housing 106 are relatively flat and planar, e.g., without curvature around axis 202 or axes parallel with the axis 202.

An axis 214 is shown extending along the first sidewall of the flexible housing 106, and an axis 216 is shown extending along the second sidewall of the flexible housing 106. In the depicted configuration, the axis 214 and the axis 216 are parallel with each other and perpendicular to the axis 202. The figure additionally shows an axis 218 extending along the first end 208 of the flexible housing 106 and an axis 220 extending along the second end 210 of the flexible housing 106. In the straightened configuration, the first end 208 and the second end 210 are parallel to each other. Further, the axis 218 is parallel with the axis 220, and each of the axis 218 and the axis 220 are perpendicular to the axis 202, the axis 216, and the axis 214.

In the depicted view, a first end portion 222 of the flexible housing 106 and a second end portion 224 of the flexible housing 106 are shown in broken lines. The first end portion 222 and the second end portion 224 indicate areas internal to the flexible housing 106 that may include straightened portions of the flexible antenna 126 in accordance with the configurations described below.

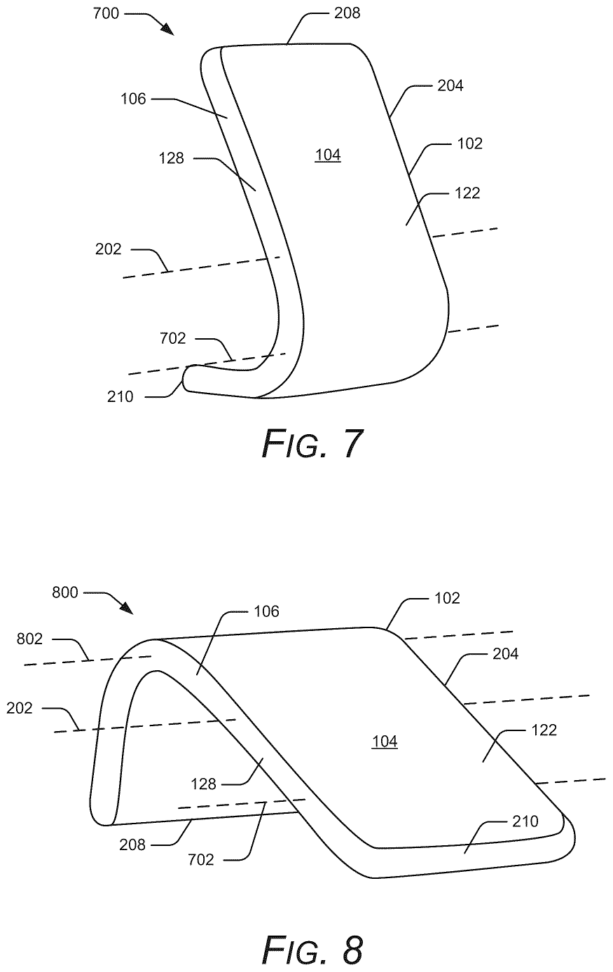

FIG. 3 illustrates an example 300 of the mobile device 102 in a flexed configuration. In the depicted example 300, the flexible housing 106 of the mobile device 102 bends along the axis 202. Although the flexible housing 106 is shown bending along the axis 202, the flexible housing 106 may be capable of bending along other axes (e.g., axes parallel with the axis 202). Examples of other flexed configurations of the flexible housing 106 are described further below with reference to FIGS. 7-8.

The mobile device 102 is shown including the flexible antenna 126. In the example 300, the flexible antenna 126 includes a flexible section 302. The flexible section 302 has an undulating shape that is described in further detail below with reference to FIG. 9. The flexible section 302 provides the flexible antenna 126 with increased flexibility such that the flexible antenna 126 is able to bend with the flexible housing 106 during conditions in which the flexible housing 106 is in a flexed configuration. Additionally, the flexible section is shaped such that the connectivity of the mobile device 102 using the flexible antenna 126 is not adversely impacted as discussed above.

In the depicted flexed configuration, the mobile device 102 may be self-supporting. For example, the first end 208 and the second end 210 may each come into direct contact with a surface on which the mobile device 102 sits such that the mobile device 102 is able to stand on the surface without additional accessories. The bending of the flexible housing 106 adjusts a spacing 304 between the first end 208 of the flexible housing 106 and the second end 210 of the flexible housing 106, where the spacing is a shortest length from the first end 208 to the second end 210.

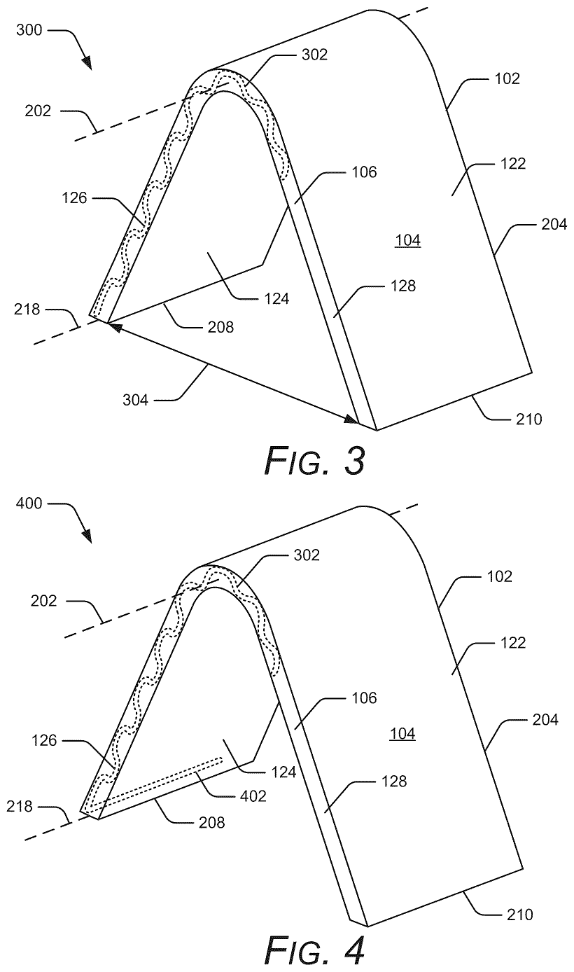

FIG. 4 illustrates another example 400 of the mobile device 102 in the flexed configuration shown by FIG. 3. In the depicted example 400, the flexible antenna 126 includes the flexible section 302 as well as a straightened section 402. The flexible antenna 126 is arranged within the flexible housing 106 such that the flexible section 302 extends along the first sidewall 128 (e.g., along length 206 of the flexible housing 106) and the straightened section 402 extends along the first end 208.

Although the flexible section 302 is depicted as extending along the first sidewall 128, in some implementations the flexible section 302 may extend along the second sidewall 204. Further, although the straightened section 402 is depicted as extending along the first end 208, in some implementations the straightened section 402 may extend along the second end 210. In yet further implementations, the flexible section 302 may extend along the first sidewall 128 and the straightened section 402 may extend along the first end 208, and the flexible antenna 126 may include a second straightened section extending along the second end 210 and/or a second flexible section extending along the second sidewall 204.

In the depicted arrangement, during conditions in which the flexible housing 106 is in a flexed configuration, the flexible section 302 of the flexible antenna 126 is able to bend along with the flexible housing 106. Additionally, as the first end 208 does not bend while the flexible housing 106 is in flexed configurations, the straightened section 402 of the flexible antenna 126 can be configured with different performance characteristics relative to the flexible section 302.

For example, the straightened section 402 may be employed to transmit and/or receive wireless electronic signals at a different frequency than wireless electronic signals transmitted and/or received using the flexible section 302. As one non-limiting example, the shape of the straightened section 402 may be associated with higher signal quality in the mid-band range (e.g., greater than one gigahertz and less than six gigahertz) and high-band range (e.g., up to forty gigahertz or more) of wireless electronic signal frequencies, while the flexible section 302 may be associated with higher signal quality in the low-band range of wireless electronic signal frequencies (e.g., less than one gigahertz). The frequency ranges (e.g., the low-band range, mid-band range, and high-band range) may not overlap in some instances (e.g., frequencies included by the low-band range may not be included by the mid-band range or the high-band range). The frequencies may be associated with wireless communication over a network, such as a wireless cellular network. The flexible section 302 is shaped to maintain a gain of the flexible antenna 126 while transitioning the flexible housing 106 from a straightened configuration (e.g., the configuration depicted by FIG. 2) to any of the plurality of flexed configurations (or vice versa).

FIG. 5 illustrates another example 500 of the mobile device 102 in the flexed configuration shown by FIGS. 3-4. In the depicted example, the mobile device 102 is shown including the flexible antenna 126, with the flexible antenna 126 including a flexible section 502 that is different relative to the flexible section 302 described above. In particular, the flexible section 502 has a helical shape. The helical shape is described in further detail below with reference to FIG. 11.

The flexible section 302 provides the flexible antenna 126 with increased flexibility such that the flexible antenna 126 is able to bend with the flexible housing 106 during conditions in which the flexible housing 106 is in a flexed configuration. Additionally, the flexible section is shaped such that the connectivity of the mobile device 102 using the flexible antenna 126 is not negatively impacted.

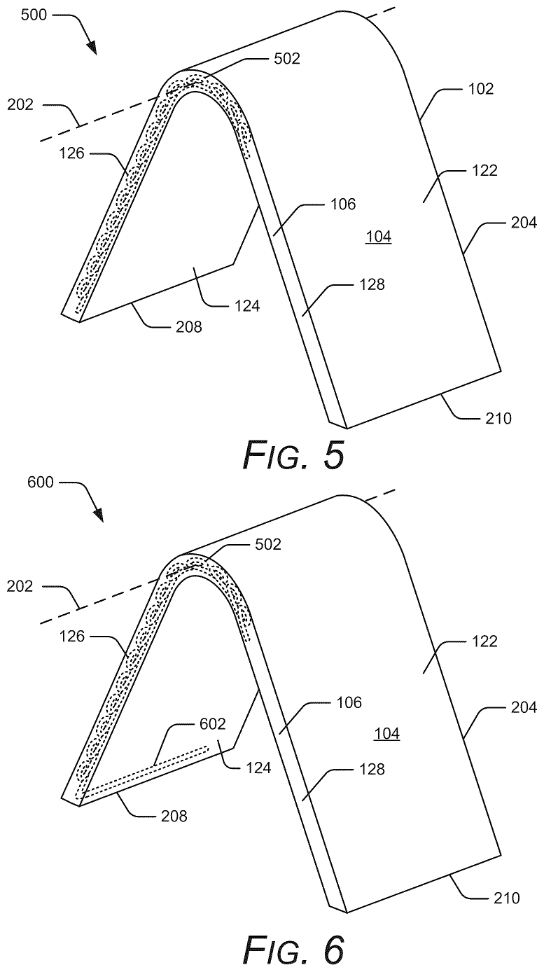

FIG. 6 illustrates another example 600 of the mobile device 102 in the flexed configuration shown by FIGS. 3-5. In the depicted example 600, the flexible antenna 126 includes the flexible section 502 as well as a straightened section 602. The flexible antenna 126 is arranged within the flexible housing 106 such that the flexible section 502 extends along the first sidewall 128 and the straightened section 602 extends along the first end 208.

Although the flexible section 502 is depicted as extending along the first sidewall 128, in some implementations the flexible section 502 may extend along the second sidewall. Further, although the straightened section 602 is depicted as extending along the first end 208, in some implementations the straightened section 602 may extend along the second end 210.

In this arrangement, during conditions in which the flexible housing 106 is in a flexed configuration, the flexible section 502 of the flexible antenna 126 is able to bend along with the flexible housing 106. The bending of the flexible antenna 126 causes the helical shape of the flexible section 302 to lengthen, such that the spacing between the adjacent turns of the helical shape increases. The helical shape of the flexible section 502 increases an elasticity of the flexible section 502, and during conditions in which the flexible housing 106 transitions from a flexed configuration (such as the configuration shown by FIG. 6) to a straightened configuration (such as the configuration shown by FIG. 2), the elasticity of the flexible section 502 restores the shape of the flexible section 502 (e.g., causes the flexible section 502 to contract by a same amount by which the flexible section 502 was lengthened).

Additionally, as the first end 208 does not bend while the flexible housing 106 is in flexed configurations, the straightened section 602 of the flexible antenna 126 can be configured with different performance characteristics relative to the flexible section 502 (e.g., to receive and/or transmit wireless electronic signals of different frequencies, similar to the examples described above with reference to FIG. 4). In the configurations depicted by FIGS. 3-6, the broken lines indicate that the flexible antenna 126 is disposed within an interior of the flexible housing 106 of the mobile device 102.

FIG. 7 illustrates an example 700 showing the mobile device 102 with the flexible housing 106 in another flexed configuration different than the flexed configuration shown by FIGS. 3-6. In particular, in the flexed configuration shown by FIG. 7, the flexible housing 106 bends along an axis 702 instead of axis 202. The axis 702 extends between the first sidewall and the second sidewall and is parallel with the axis 202. In this configuration, the first end 208 extends upward away from a surface on which the mobile device 102 sits. In the depicted flexed configuration, the mobile device 102 may be self-supporting. The mobile device 102 can be self-supporting against a surface by arranging a portion of the flexible display 104 against the surface (e.g., with a portion of the flexible display 104 facing the surface and with another portion of the flexible display 104 extending above the surface for viewing media, interacting with a graphical user interface displayed by the flexible display 104, etc.).

FIG. 8 illustrates an example 800 showing the mobile device 102 with the flexible housing 106 in another flexed configuration different than the flexed configuration shown by FIGS. 3-6 and the flexed configuration shown by FIG. 7. In particular, in the flexed configuration shown by FIG. 8, the flexible housing 106 bends along an axis 802 instead of axis 202 or axis 702. The axis 802 extends between the first sidewall and the second sidewall and is parallel with the axis 202 and the axis 702. In this configuration, the first end 208 and the second end 210 each directly contact the surface on which the mobile device 102 sits during conditions in which the mobile device 102 is self-supporting against the surface.

Relative to the flexed configuration shown by FIGS. 3-6, in the flexed configuration shown by FIG. 8, a curvature of the bend is offset from the center of the flexible housing 106. In particular, an apex of the curvature is spaced apart from the axis 202, where the axis 202 is arranged at a location centered between the first end 208 and the second end 210 along the first side 122.

FIG. 9 illustrates an example 900 showing a side view of the flexible antenna 126 in the configuration described above with reference to FIG. 3. The figure depicts parallel axes arranged at opposing ends of the flexible antenna 126. In particular, an axis 902 is arranged at a first end 904 of the flexible antenna 126, and an axis 906 is arranged at a second end 908 of the flexible antenna 126. The first end 904 is opposite to the second end 908, and the axis 902 is parallel to the axis 906.

A length 910 of the flexible antenna 126 extends between the first end 904 and the second end 908 (e.g., from the axis 902 to the axis 906). The length 910 is in a direction perpendicular to each of the axis 902 and the axis 906 and parallel to an axis 912 extending from the first end 904 to the second end 908. The axis 912 is centered relative to the flexible antenna 126 in the vertical direction in the view of FIG. 9 and may be referred to herein as a centerline of the flexible antenna 126.

The flexible section 302 of the flexible antenna 126 has an undulating shape that includes a plurality of alternating peaks (e.g., peak 914) and troughs (e.g., trough 916). In the depicted example, the peaks are aligned along an axis 918, and the troughs are aligned along an axis 920. The axis 918 and the axis 920 are each parallel with the axis 912, with the axis 918 offset from the axis 912 in a direction perpendicular to the 912 and the axis 920 offset from the axis 912 in an opposite direction.

In the depicted example, a magnitude of a spacing of the axis 918 from the axis 912 is equal to a magnitude of a spacing of the axis 920 from the axis 912. In this configuration, each of the peaks is spaced apart from the centerline of the flexible antenna 126 in the vertical direction by a same amount, and each of the troughs is spaced apart from the centerline of the flexible antenna 126 in the vertical direction by a same amount (with the axis 912 extending along the centerline of the flexible antenna 126). The distance of each peak from the centerline of the flexible antenna 126 is thus equal to the distance of each trough from the centerline of the flexible antenna 126. In other implementations, one or more of the peaks may have a different spacing from the centerline, and/or one or more of the troughs may have a different spacing from the centerline.

Each peak is spaced apart from each adjacent peak by a same amount along the length 910 of the flexible antenna 126 in the depicted example. Further, each trough is spaced apart from each adjacent trough by a same amount along the length 910 of the flexible antenna 126 in the depicted example. In other implementations, one or more of the peaks may be spaced apart from adjacent peaks by a different amount, and/or one or more of the troughs may be spaced apart from adjacent troughs by a different amount. For example, the figure shows an axis 922, an axis 924, and an axis 926 extending parallel to each other and perpendicular to the axis 912. The axis 922 intersects a first peak, the axis 924 intersects a second peak adjacent to the first peak, and the axis 926 intersects a third peak adjacent to the second peak. In this configuration, the second peak is centered between the first peak and the third peak and is adjacent to each of the first peak and the third peak.

Although in the depicted example a length 928 between the first peak and the second peak (e.g., between the axis 922 and the axis 924) is equal to a length 930 between the second peak and the third peak (e.g., between the axis 924 and the axis 926), in some implementations the length 930 may be a different amount of length than the length 928. Configuring the flexible antenna 126 with different peak spacing and/or different trough spacing may facilitate use of the flexible antenna 126 with a wide variety of flexible housing 106 configurations. For example, in configurations of the mobile device 102 in which the flexible housing 106 is capable of bending by larger amounts (e.g., ninety degrees), the peak spacing and/or trough spacing may be smaller. In configurations in which the flexible housing 106 is capable of bending by smaller amounts (e.g., sixty degrees), the peak spacing and/or trough spacing may be larger. Thus, the particular shape of the flexible antenna 126 can be configured to provide suitable flexibility (e.g., to accommodate for bending of the flexible housing 106) while also providing the desired connectivity characteristics.

The flexible section 302 of the flexible antenna 126 may lengthen while the flexible housing 106 bends and may contract while the flexible housing 106 is straightened. For example, while the flexible housing 106 bends, the flexible antenna 126 also bends. The bending of the flexible antenna 126 causes the undulating shape of the flexible section 302 to lengthen, such that the spacing between the adjacent peaks and the adjacent troughs described above increases. The undulating shape of the flexible section 302 increases an elasticity of the flexible section 302, and during conditions in which the flexible housing 106 transitions from a flexed configuration (such as the configuration shown by FIG. 3) to a straightened configuration (such as the configuration shown by FIG. 2), the elasticity of the flexible section 302 restores the shape of the flexible section 302 (e.g., causes the flexible section 302 to contract by a same amount by which the flexible section 302 was lengthened).

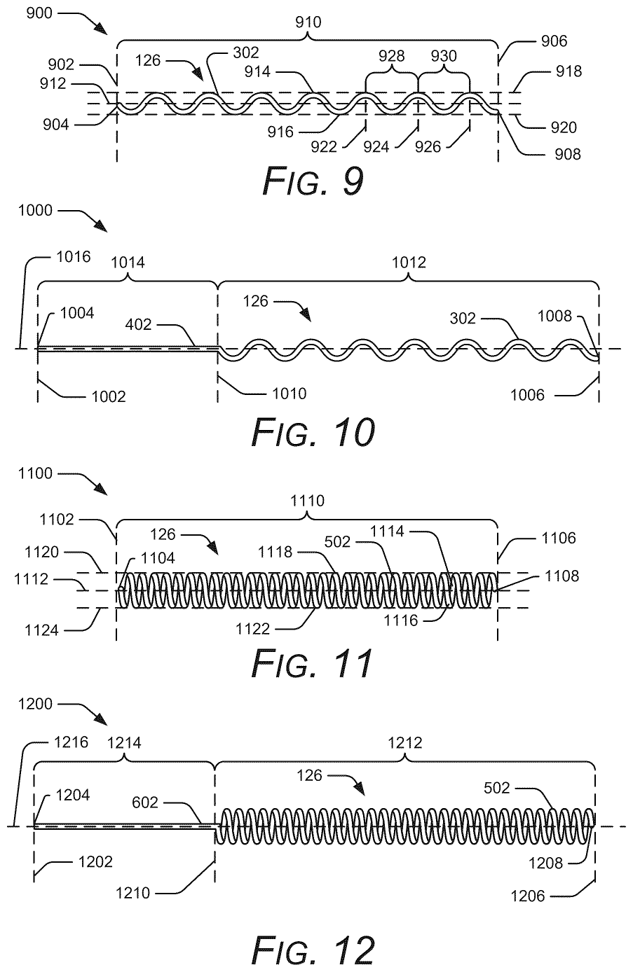

FIG. 10 illustrates an example 1000 showing a side view of the flexible antenna 126 in the configuration described above with reference to FIG. 4. The figure depicts parallel axes arranged at opposing ends of the flexible antenna 126. In particular, an axis 1002 is arranged at a first end 1004 of the flexible antenna 126, and an axis 1006 is arranged at a second end 1008 of the flexible antenna 126. The first end 1004 is opposite to the second end 1008 and the axis 1002 is parallel to the axis 1006.

An axis 1010 is additionally depicted parallel with the axis 1002 and the axis 1006 and arranged at a location at which the flexible section 302 of the flexible antenna 126 joins to the straightened section 402 of the flexible antenna 126. In implementations, the flexible section 302 and the straightened section 402 are formed together as a single unit (e.g., formed from a single piece of continuous material).

A length 1012 of the flexible section 302 of the flexible antenna 126 extends from the axis 1010 to the axis 1006. A length 1014 of the straightened section 402 of the flexible antenna 126 extends from the axis 1002 to the axis 1010. The length 1012 and the length 1014 are each in a direction perpendicular to the axis 1002, the axis 1010, and the axis 1006, and parallel to an axis 1016 extending from the first end 1004 to the second end 1008. The axis 1016 is centered relative to the flexible antenna 126 in the vertical direction in the view of FIG. 10 and may be referred to herein as a centerline.

The flexible section 302 of the flexible antenna 126 includes a plurality of alternating peaks and troughs similar to those described above with reference to FIG. 9, while the straightened section 402 extends without curvature, e.g., without the peaks and troughs of the flexible section 302. In the depicted configuration, the length 1014 of the straightened section 402 is smaller than the length 1012 of the flexible section 302. The shortened length 1014 of the straightened section 402 relative to the longer length 1012 of the flexible section 302 supports arrangement of the straightened section 402 at an end of the mobile device 102 (e.g., first end 208 or second end 210) while the flexible section 302 is arranged at a sidewall of the mobile device 102 (e.g., first sidewall 128 or second sidewall 204). As a result, connectivity using mid-band and high-band wireless electronic signal frequencies, which can be transmitted and received using shorter antenna lengths, can be supported by the straightened section 402 at the end of the mobile device 102 without the straightened section 402 bending during conditions in which the flexible housing 106 bends. Additionally, connectivity using low-band wireless electronic signal frequencies, which utilizes longer antenna lengths, can be supported by the straightened section 402 and the flexible section 302. For example, electronic signals associated with low-band frequencies can be received and/or transmitted by both of the straightened section 402 and the flexible section 302 concurrently.

FIG. 11 illustrates an example 1100 showing a side view of the flexible antenna 126 in the configuration described above with reference to FIG. 5. The figure depicts parallel axes arranged at opposing ends of the flexible antenna 126. In particular, an axis 1102 is arranged at a first end 1104 of the flexible antenna 126, and an axis 1106 is arranged at a second end 1108 of the flexible antenna 126. The first end 1104 is opposite to the second end 1108 and the axis 1102 is parallel to the axis 1106.

A length 1110 of the flexible antenna 126 extends between the first end 1104 and the second end 1108 (e.g., from the axis 1102 to the axis 1106). The length 1110 is in a direction perpendicular to each of the axis 1102 and the axis 1106 and parallel to an axis 1112 extending from the first end 1104 to the second end 1108. The axis 1112 is centered relative to the flexible antenna 126 in the vertical direction in the view of FIG. 11 and may be referred to herein as a centerline of the flexible antenna 126.

In the depicted example, the flexible antenna 126 includes a flexible section 502 having a helical shape. The flexible section 502 is formed as a single continuous piece of material that curves (e.g., turns) around the axis 1112 in a helical manner. In the side view shown by the figure, some portions of the flexible section 502 are depicted as arranged further from the plane of view, such as a portion 1114, and other portions of the flexible section 502 are depicted as arranged closer to the plane of view, such as a portion 1116. The helical shape of the flexible section 502 is depicted with a particular number of turns, also referred to as pitch. However, in some implementations, the number of turns may be different.

The flexible section 502 of the flexible antenna 126 may lengthen while the flexible housing 106 bends and may contract while the flexible housing 106 is straightened. The flexible section 502 forms plurality of alternating peaks and troughs associated with upper portions and lower portions, respectively, of the turns of the flexible section 502 in the depicted view. For example, the peaks (such as peak 1118) are aligned along an axis 1120, and the troughs (such as trough 1122) are aligned along an axis 1124. The axis 1120 and the axis 1124 are each parallel with the axis 1112, with the axis 1120 offset from the axis 1112 in a direction perpendicular to the axis 1112 and the axis 1124 offset from the axis 1112 in an opposite direction. The axis 1120 and the axis 1124 are depicted as spaced apart equidistantly from the axis 1112, similar to the example described above with reference to axis 918, axis 920, and axis 912 depicted by FIG. 9.

In the depicted example, each peak is spaced apart from each adjacent peak by a same amount along the length 1110 of the flexible antenna 126, and each trough is spaced apart from each adjacent trough by a same amount along the length 1110 of the flexible antenna 126. However, in some implementations, the spacing may be different, similar to the different spacing of peaks and troughs described above with reference to FIG. 9.

FIG. 12 illustrates an example 1200 showing a side view of the flexible antenna 126 in the configuration described above with reference to FIG. 6. The figure depicts parallel axes arranged at opposing ends of the flexible antenna 126. In particular, an axis 1202 is arranged at a first end 1204 of the flexible antenna 126, and an axis 1206 is arranged at a second end 1208 of the flexible antenna 126. The first end 1204 is opposite to the second end 1208 and the axis 1202 is parallel to the axis 1206.

An axis 1210 is additionally depicted parallel with the axis 1202 and the axis 1206 and arranged at a location at which the flexible section 502 of the flexible antenna 126 joins to the straightened section 602 of the flexible antenna 126. In implementations, the flexible section 502 and the straightened section 602 are formed together as a single unit (e.g., formed from a single piece of continuous material).

A length 1212 of the flexible section 502 of the flexible antenna 126 extends from the axis 1210 to the axis 1206. A length 1214 of the straightened section 602 of the flexible antenna 126 extends from the axis 1202 to the axis 1210. The length 1214 and the length 1212 are each in a direction perpendicular to the axis 1202, the axis 1210, and the axis 1206, and parallel to an axis 1216 extending from the first end 1204 to the second end 1208. The axis 1216 is centered relative to the flexible antenna 126 in the vertical direction in the view of FIG. 12 and may be referred to herein as a centerline of the flexible antenna 126.

The flexible section 502 of the flexible antenna 126 has a helical shape forming a plurality of alternating peaks and troughs similar to those described above with reference to FIG. 11. The straightened section 602 extends without curvature, e.g., without the helical shape of the flexible section 502.

In the depicted configuration, the length 1214 of the straightened section 602 is smaller than the length 1212 of the flexible section. The shortened length 1214 of the straightened section 602 relative to the longer length 1212 of the flexible section 502 supports arrangement of the straightened section 602 at an end of the mobile device 102 (e.g., first end 208 or second end 210) while the flexible section 502 is arranged at a sidewall of the mobile device 102 (e.g., first sidewall 128 or second sidewall 204). As a result, connectivity using mid-band and high-band wireless electronic signal frequencies, which can be transmitted and received using shorter antenna lengths, can be supported by the straightened section 602 at the end of the mobile device 102 without the straightened section 602 bending during conditions in which the flexible housing 106 bends. Additionally, connectivity using low-band wireless electronic signal frequencies, which utilizes longer antenna lengths, can be supported by the straightened section 602 and the flexible section 502. For example, electronic signals associated with low-band frequencies can be received and/or transmitted by both of the straightened section 602 and the flexible section 502 concurrently.

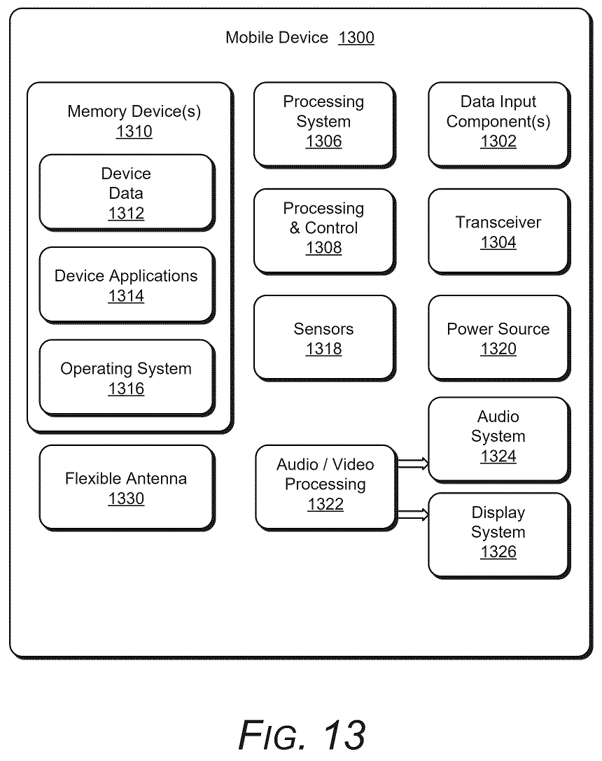

FIG. 13 illustrates various components of an example mobile device 1300 in which embodiments of a flexible display and flexible antenna can be implemented. The mobile device 1300 can be implemented as any of the devices described with reference to the previous FIGs, such as any type of client device, mobile phone, tablet, computing, communication, entertainment, gaming, media playback, or other type of mobile device. In one or more embodiments the mobile device 1300 is mobile device 102, the display system 1326 includes the flexible display 104, and the flexible antenna 1330 is the flexible antenna 126, described above.

The mobile device 1300 includes one or more data input components 1302 via which any type of data, media content, or inputs can be received such as user-selectable inputs, messages, music, television content, recorded video content, and any other type of text, audio, video, or image data received from any content or data source. The data input components 1302 may include various data input ports such as universal serial bus ports, coaxial cable ports, and other serial or parallel connectors (including internal connectors) for flash memory, DVDs, compact discs, and the like. These data input ports may be used to couple the mobile device to components, peripherals, or accessories such as keyboards, microphones, or cameras. The data input components 1302 may also include various other input components such as microphones, touch sensors, touchscreens, keyboards, and so forth.

The mobile device 1300 includes communication transceivers 1304 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The mobile device 1300 includes a processing system 1306 of one or more processors (e.g., any of microprocessors, controllers, and the like) or a processor and memory system implemented as a system-on-chip (SoC) that processes computer-executable instructions. The processing system 1306 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 1308. The mobile device 1300 may further include any type of a system bus or other data and command transfer system that couples the various components within the device. A system bus can include any one or combination of different bus structures and architectures, as well as control and data lines.

The mobile device 1300 also includes computer-readable storage memory devices 1310 that enable data storage, such as data storage devices that can be accessed by a mobile device, and that provide persistent storage of data and executable instructions (e.g., software applications, programs, functions, and the like). Examples of the computer-readable storage memory devices 1310 include volatile memory and non-volatile memory, fixed and removable media devices, and any suitable memory device or electronic data storage that maintains data for mobile device access. The computer-readable storage memory can include various implementations of random access memory (RAM), read-only memory (ROM), flash memory, and other types of storage media in various memory device configurations. The mobile device 1300 may also include a mass storage media device.

The computer-readable storage memory device 1310 provides data storage mechanisms to store the device data 1312, other types of information or data, and various device applications 1314 (e.g., software applications). For example, an operating system 1316 can be maintained as software instructions with a memory device and executed by the processing system 1306. The device applications 1314 may also include a device manager, such as any form of a control application, software application, signal-processing and control module, code that is native to a particular device, a hardware abstraction layer for a particular device, and so on.

The mobile device 1300 can also include one or more device sensors 1318, such as any one or more of an ambient light sensor, a proximity sensor, a touch sensor, an infrared (IR) sensor, accelerometer, gyroscope, thermal sensor, audio sensor (e.g., microphone), and the like. The mobile device 1300 can also include one or more power sources 1320, such as when the mobile device 1300 is implemented as a mobile device. The power sources 1320 may include a charging or power system, and can be implemented as a flexible strip battery, a rechargeable battery, a charged super-capacitor, or any other type of active or passive power source.

The mobile device 1300 additionally includes an audio or video processing system 1322 that generates one or both of audio data for an audio system 1324 and display data for a display system 1326. In accordance with some embodiments, the audio/video processing system 1322 is configured to receive call audio data from the transceiver 1304 and communicate the call audio data to the audio system 1324 for playback at the mobile device 1300. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although embodiments of techniques for a mobile device with flexible display and flexible antenna have been described in language specific to features or methods, the subject of the appended claims is not necessarily limited to the specific features or methods described. Rather, the specific features and methods are disclosed as example implementations of techniques for implementing a mobile device with flexible display and flexible antenna. Further, various different embodiments are described, and it is to be appreciated that each described embodiment can be implemented independently or in connection with one or more other described embodiments. Additional aspects of the techniques, features, and/or methods discussed herein relate to one or more of the following:
In some aspects, the techniques described herein relate to a mobile device, including: a flexible housing bendable to a plurality of flexed configurations; a flexible display disposed within the flexible housing and bendable with the flexible housing; and a flexible antenna disposed within the flexible housing and shaped to bend with the flexible housing and the flexible display.
In some aspects, the techniques described herein relate to a mobile device, wherein the flexible antenna includes a flexible section shaped to lengthen while the flexible housing is in any of the plurality of flexed configurations and contract while the flexible housing is in a straightened configuration.
In some aspects, the techniques described herein relate to a mobile device, wherein the flexible section lengthens in a direction from a first end of the flexible housing toward a second end of the flexible housing, the first end and the second end opposite to each other along a length of the flexible housing, the flexible housing bendable along the length to adjust a spacing between the first end and the second end.
In some aspects, the techniques described herein relate to a mobile device, wherein the flexible section is shaped to maintain a gain of the flexible antenna while transitioning the flexible housing from a straightened configuration to any of the plurality of flexed configurations or vice versa.
In some aspects, the techniques described herein relate to a mobile device, wherein the flexible section has a helical shape including a plurality of turns.
In some aspects, the techniques described herein relate to a mobile device, wherein the flexible section has an undulating shape including a plurality of peaks and a plurality of troughs.
In some aspects, the techniques described herein relate to a mobile device, wherein the flexible antenna includes a flexible section and a straightened section, the flexible section shaped to receive and transmit electronic signals in a first frequency range and the straightened section configured to receive and transmit electronic signals in a second frequency range.
In some aspects, the techniques described herein relate to a mobile device, wherein the flexible section and the straightened section are formed together as a single unit.
In some aspects, the techniques described herein relate to a mobile device, wherein the straightened section extends perpendicular to the flexible section.
In some aspects, the techniques described herein relate to a mobile device, wherein the flexible antenna includes a flexible section extending along a sidewall of the flexible housing and a straightened section extending along an end of the flexible housing, the end perpendicular to the sidewall.
In some aspects, the techniques described herein relate to a system including: a flexible display; a flexible antenna including a flexible section shaped to bend with the flexible display, and a straightened section angled relative to the flexible section; at least one memory; and at least one processor coupled with the at least one memory and configured to cause the system to: receive or transmit wireless electronic signals within a first frequency range via the flexible section and the straightened section; and receive or transmit wireless electronic signals within a second frequency range via the straightened section.
In some aspects, the techniques described herein relate to a system, wherein the first frequency range and the second frequency range do not overlap.
In some aspects, the techniques described herein relate to a system, wherein the first frequency range includes frequencies less than one gigahertz, and the second frequency range includes frequencies greater than one gigahertz.
In some aspects, the techniques described herein relate to a system, wherein the straightened section extends perpendicular to the flexible section and is maintained perpendicular to the flexible section while the flexible section bends.
In some aspects, the techniques described herein relate to a system, wherein the flexible section is shaped to bend without bending the straightened section.
In some aspects, the techniques described herein relate to a mobile device including: a flexible housing bendable to a plurality of flexed configurations; a flexible display disposed within the flexible housing and bendable with the flexible housing; a flexible antenna disposed within the flexible housing and shaped to bend with the flexible housing and the flexible display; at least one memory; and at least one processor coupled with the at least one memory and configured to cause the mobile device to: communicate wirelessly over a network using a first section and a second section of the flexible antenna configured to transmit and receive wireless electronic signals in a first frequency range; and communicate wirelessly over the network using the second section of the flexible antenna configured to transmit and receive wireless electronic signals in a second frequency range.
In some aspects, the techniques described herein relate to a mobile device, wherein the network is a wireless cellular network, the first frequency range includes frequencies less than one gigahertz, the second frequency range includes frequencies greater than one gigahertz, and the first frequency range and the second frequency range do not overlap.
In some aspects, the techniques described herein relate to a mobile device, wherein the first section has an undulating shape or a helical shape, and the second section has a straightened shape.
In some aspects, the techniques described herein relate to a mobile device, wherein the flexible antenna is shaped to lengthen while the flexible housing is in any of the plurality of flexed configurations and contract while the flexible housing is in a straightened configuration.
In some aspects, the techniques described herein relate to a mobile device, wherein the first section extends along a sidewall of the flexible housing and the second section extends along an end of the flexible housing, the end perpendicular to the sidewall.

What is claimed is:

1. A mobile device, comprising:
a flexible housing bendable to a plurality of flexed configurations;
a flexible display disposed within the flexible housing and bendable with the flexible housing; and
a flexible antenna disposed within the flexible housing and shaped to bend with the flexible housing and the flexible display.

2. The mobile device of claim 1, wherein the flexible antenna includes a flexible section shaped to lengthen while the flexible housing is in any of the plurality of flexed configurations and contract while the flexible housing is in a straightened configuration.

3. The mobile device of claim 2, wherein the flexible section lengthens in a direction from a first end of the flexible housing toward a second end of the flexible housing, the first end and the second end opposite to each other along a length of the flexible housing, the flexible housing bendable along the length to adjust a spacing between the first end and the second end.

4. The mobile device of claim 2, wherein the flexible section is shaped to maintain a gain of the flexible antenna while transitioning the flexible housing from a straightened configuration to any of the plurality of flexed configurations or vice versa.

5. The mobile device of claim 2, wherein the flexible section has a helical shape including a plurality of turns.

6. The mobile device of claim 2, wherein the flexible section has an undulating shape including a plurality of peaks and a plurality of troughs.

7. The mobile device of claim 1, wherein the flexible antenna includes a flexible section and a straightened section, the flexible section and the straightened section configured to receive and transmit electronic signals in a first frequency range, and the straightened section further configured to receive and transmit electronic signals in a second frequency range.

8. The mobile device of claim 7, wherein the flexible section and the straightened section are formed together as a single unit.

9. The mobile device of claim 7, wherein the straightened section extends perpendicular to the flexible section.

10. The mobile device of claim 1, wherein the flexible antenna includes a flexible section extending along a sidewall of the flexible housing and a straightened section extending along an end of the flexible housing, the end perpendicular to the sidewall.

11. A system comprising:
a flexible display;
a flexible antenna including a flexible section shaped to bend with the flexible display, and a straightened section angled relative to the flexible section;
at least one memory; and
at least one processor coupled with the at least one memory and configured to cause the system to:
receive or transmit wireless electronic signals within a first frequency range via the flexible section and the straightened section; and
receive or transmit wireless electronic signals within a second frequency range via the straightened section.

12. The system of claim 11, wherein the first frequency range and the second frequency range do not overlap.

13. The system of claim 11, wherein the first frequency range includes frequencies less than one gigahertz, and the second frequency range includes frequencies greater than one gigahertz.

14. The system of claim 11, wherein the straightened section extends perpendicular to the flexible section and is maintained perpendicular to the flexible section while the flexible section bends.

15. The system of claim 11, wherein the flexible section is shaped to bend without bending the straightened section.

16. A mobile device comprising:
a flexible housing bendable to a plurality of flexed configurations;
a flexible display disposed within the flexible housing and bendable with the flexible housing;
a flexible antenna disposed within the flexible housing and shaped to bend with the flexible housing and the flexible display;
at least one memory; and
at least one processor coupled with the at least one memory and configured to cause the mobile device to:
communicate wirelessly over a network using a first section and a second section of the flexible antenna configured to transmit and receive wireless electronic signals in a first frequency range; and
communicate wirelessly over the network using the second section of the flexible antenna configured to transmit and receive wireless electronic signals in a second frequency range.

17. The mobile device of claim 16, wherein the network is a wireless cellular network, the first frequency range includes frequencies less than one gigahertz, the second frequency range includes frequencies greater than one gigahertz, and the first frequency range and the second frequency range do not overlap.

18. The mobile device of claim 17, wherein the first section has an undulating shape or a helical shape, and the second section has a straightened shape.

19. The mobile device of claim 16, wherein the flexible antenna is shaped to lengthen while the flexible housing is in any of the plurality of flexed configurations and contract while the flexible housing is in a straightened configuration.

20. The mobile device of claim 16, wherein the first section extends along a sidewall of the flexible housing and the second section extends along an end of the flexible housing, the end perpendicular to the sidewall.
